(19) United States
(12) Patent Application Publication
(10) Pub. No.: US 2010/0103910 A1
(43) Pub. Date: Apr. 29, 2010

(54) SMART DEVICE PROFILING

(76) Inventor: Mohan Verma, Sunnyvale, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/259,989

(22) Filed: Oct. 28, 2008

(51) Int. Cl. H04W 92/12

(52) U.S. Cl. 370/338

(57) ABSTRACT

Providing device profiles for devices attached to local ports of access nodes on a wireless network. A device connected to a local port of an access node on a wireless network, such as a USB, IEEE1394 or wired IEEE 802.3 Ethernet port, is identified and the identification information sent to the controller. The controller may send further queries to the access node to be executed in further identifying the device. The controller configures the appropriate profile for the device and sends the profile to the access node. The profile may contain access control information such as access control lists.

### BACKGROUND OF THE INVENTION

The present invention relates to supporting digital devices, and in particular, to the problem of supporting digital devices attached to access nodes in a wireless digital network.

Wireless local area networks (WLANs) support a wide range of client devices. In general a WLAN is comprised of one or more controllers which each support one or more wireless access nodes. Access nodes provide wireless services to clients, often using protocols complying with IEEE 802.11 standards. Access nodes may communicate with their controller by a wired connection, such as an IEEE 802.3 wired Ethernet connection, wireless connections such as mesh networks or networks using WiMAX, 3G, or other wireless backhauls, or a combination of these, such as connections over a switched network such as through DSL or cable modems.

While many client devices, such as portable computers, WiFi phones, wireless scanners, and the like, often include wireless interfaces, it is some times desirable to connect devices to the WLAN which do not have wireless interfaces. Such devices may have older USB wired interfaces, IEEE 1394 interfaces, or wired Ethernet interfaces. Examples of USB, IEEE 1394, and wired Ethernet based devices include memory devices, audio input and output devices, cameras, scanners, VOIP phones, printers, and other devices ranging from simple device interfaces to complex laboratory instruments.

Access nodes on the WLAN have local ports such as USB, IEEE 1394 and/or wired Ethernet, to which such devices may be attached.

It is understood in the art that while the low level interfaces to such local ports operate according to standards, which by definition are agreed upon and well known, the actual configuration and operation of the device, such as printing a color picture, generating a sound, or transferring a still or moving image for example, require more specialized software. This software may be simple configuration software, or it may be more complex support software for the device. But, for a device to be attached and operated as part of the networking infrastructure, the device must be configured on both the access nodes of the WLAN, and on the controller. Performing such configuration manually is both time intensive and error prone.

It is impractical for each access node having local ports to contain all the software required to configure and operate all possible devices.

What is needed is a method of simplifying the configuration of devices attached to access nodes on a wireless network.

### BRIEF DESCRIPTION OF THE DRAWINGS

The invention may be best understood by referring to the following description and accompanying drawings that are used to illustrate embodiments of the invention in which:

FIG. 1 shows a wireless 802.11 network, and

FIG. 2 shows a flowchart of device configuration

### DETAILED DESCRIPTION

Embodiments of the invention relate to methods of configuring devices attached to local ports of access nodes on a wireless network. Access nodes on the wireless network are connected to a controller. Such local ports include but are not limited to USB, IEEE 1394, and/or wired IEEE 802.3 Ethernet. According to an aspect of the invention, when a device is attached to a local port on an access node, the access node performs initial device identification. If the identification process is successful, device information is sent to the controller. The controller may send further queries to the access node to be executed by the access node targeting the device attached to the local port, with the access node returning status information to the controller. If possible, the controller configures the required profile for the device and pushes the profile to the access node. The profile may contain interface descriptions, code, drivers, descriptions, and other computer data and instructions necessary to operate the device. In another embodiment of the invention, the profile sent to the access node may include access control information defining and/or limiting access to the device.

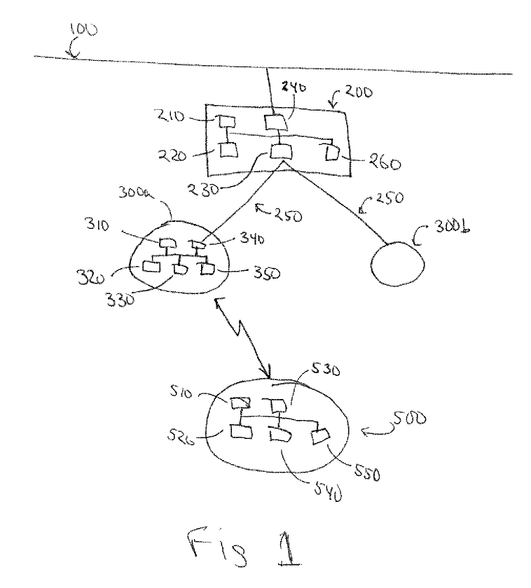

As shown in FIG. 1, wireless network operating according to 802.11 standards supports connections of wireless clients 400 to a wired network. Wired network 100, such as a wired IEEE 802.3 Ethernet network, is connected to controller 200. Controller 200 supports connections 250 to access nodes 300a, 300b, 300c. These access nodes provide wireless communications to wireless clients 400b.

As is understood in the art, controller 200 is a purpose-built digital device having a CPU 210, memory hierarchy 220, and a plurality of network interfaces 230, 240. CPU 210 may be a MIPS-class processor from companies such as Raza Microelectronics or Cavium Networks, although CPUs from companies such as Intel, AMD, IBM, Freescale, or the like may also be used. Memory hierarchy 220 includes read-only memory for device startup and initialization, high-speed read-write memory such as DRAM for containing programs and data during operation, and bulk memory such as hard disk or compact flash for permanent file storage of programs and data. Network interfaces 230, 240 are typically IEEE 802.3 Ethernet interfaces to copper, although high-speed optical fiber interfaces may also be used. Controller 200 typically operates under the control of purpose-built embedded software, typically running under a Linux operating system, or an operating system for embedded devices such as VXWorks.

Similarly, as understood by the art, wired and wireless access nodes 300a, 300b are also purpose-built digital devices. These access nodes include CPUs 310, memory hierarchy 320, wireless interface 330 and controller interface 340. Controller interface 340 may be a wired interface, such as an Ethernet 802.3 interface, or a combination of wired and wireless interfaces, as an example, WiMAX, 802.11 WiFi, ADSL, cable modem, or the like.

Access nodes 300 include local interface 350. Local interface 350 may be a USB, IEEE1394, or IEEE802.3 wired Ethernet interface, or other suitable interface. As with controller 200, the CPU commonly used for such access nodes is a MIPS-class CPU such as one from Raza Microelectronics or Cavium Networks, although processors from other vendors such as Intel, AMD, Freescale, and IBM may be used. The memory hierarchy comprises read-only storage for device startup and initialization, fast read-write storage such as DRAM for holding operating programs and data, and permanent bulk file storage such as compact flash. Wireless access nodes 300 typically operate under control of purpose-built programs running on an embedded operating system such as Linux or VXWorks. Wireless interfaces 330 are typically interfaces operating to the family of IEEE 802.11 standards including but not limited to 802.11a, b, g, and/or n.

Wireless client 500 is also a digital device, similarly having CPU 510, memory hierarchy 520, wireless interface 530, and I/O devices 540, 550. As examples, wireless device 500 may be a general purpose computer such as a laptop, or may be a purpose-built device such as a Wi-Fi phone or a handheld scanner. In a general-purpose computer, CPU 510 may be a processor from companies such as Intel, AMD, Freescale, or the like. In the case of purpose-built devices, Acorn or MIPS class processors may be preferred. Memory hierarchy 520 comprises the similar set of read-only memory for device startup and initialization, fast read-write memory for device operation and holding programs and data during execution, and permanent bulk file storage using devices such as flash, compact flash, and/or hard disks. Additional I/O devices 540, 550 may be present, such as keyboards, displays, speakers, barcode scanners, and the like.

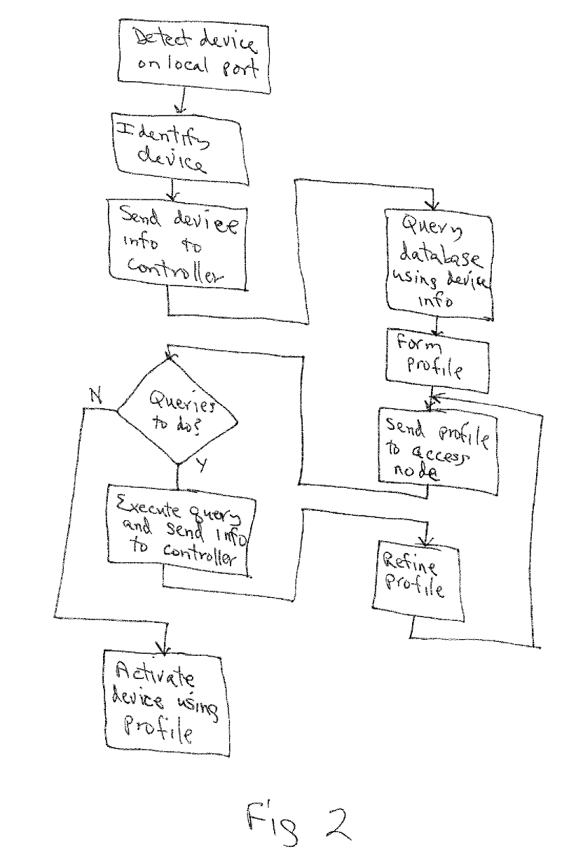

According to an aspect of the invention, and as shown in the flowchart of FIG. 2, a method of providing a profile to support a device connected to a local port on an access node is provided. Access node 300 identifies a device connected to local port 350. This detection may take place during initialization of access node 300, or may take place by detecting the connection of the device to local port 350. As is understood in the art, interfaces such as USB, IEEE1394, and IEEE802.3 include the ability to detect when a device is connected.

Once access node 300 determines that a device is present at local port 350, it attempts to identify the device. This is done, for example, through the use of status queries defined by the local port. As examples, both USB and IEEE 1394 protocols define queries for interrogating devices and having the device return information such as manufacturer information, product ID, vendor ID, and so on. Similar approaches are possible with wired Ethernet. In one approach, messages are sent to the device in sequence until the device responds to a particular message.

When access node 300 receives a response from the device attached to local port 350, it sends this information to controller 200.

Controller 200 takes this information and queries its device database 260. Database 260 may contain a profile for the device, or it may contain queries to be executed by access node 300 to determine the profile needed for the device. While database 260 is shown as apart of controller 200, it may be located external to controller 200, as long as it is accessible to controller 200, such as on network 100. Queries retrieved are sent to access node 300, and access node 300 executes these queries targeting the device attached to local port 350. Returned information is sent back to controller 200.

When controller 200 has sufficient information to identify the device attached to local port 350, it configures the required profile and sends that profile to controller 300.

Controller 300 installs the profile, activating the device attached to local port 350, making it available to clients of access node 300 and possibly to clients able to access controller 200 such as other access nodes 300 and other network devices connected to network 100.

If no profile is available for the device, or the configuration is not supported, a warning may be flagged and sent to access node 300. This warning may be displayed for example on a web-based operator interface for access node 300, allowing a properly privileged operator to configure additional parameters for operating the device.

The identification information on the device connected to local port 350 may also be stored at controller 200 for later analysis and further lookup. As an example, identification information may be turned into queries sent over the Internet to the controller manufacturer, identifying a possibly novel device, and inquiring if a profile is available. If a profile is available, it may be downloaded from the manufacturer, updating database 260 by controller 200, and pushing the profile to access node 300.

For standard classes of devices, as an example standard mass storage or video devices for which drivers may already be present in access node 300, the process of identifying the device attached to the local port and sending this information to controller 200 may be used to enforce local policy as to what kinds of devices may be attached to access node 300. As an example, while it may be appropriate for an outdoor access node to support a video camera, local policy may prohibit video cameras from being connected to access nodes in dormitory areas. Similarly, while all access points of a certain class may contain support for USB color printers, an attempt to connect a USB color printer to an access node designated as located atop a pole in a parking lot should probably be flagged as an error.

According to another aspect of the invention, the profile may optionally contain access control information. This access control information may determine what access is permissible by what class of users. As an example, if a video camera is connected to local port 350 of access node 300, while a first class or group of users may be allowed to view the images produced by the camera, only a second class or group of users may be allowed to alter camera parameters, such as positioning and zoom. Similarly, a printer connected to an access node may be made accessible to all users of the access node, or only to a restricted set or group of users. A mass storage device may be segregated into no access, read-only, or read-write access groups.

Additionally, the profile may contain optional operational information such as quality of service (QOS) parameters and/or routing information. A device such as a printer may be made available only to locally connected wireless clients of access node 300, or it may be made available to all users of the WLAN. Similarly a device such as a video camera may be available only to local clients, or to authorized clients throughout the WLAN, and data from the video camera may be marked high priority according to QOS rules.

While the invention has been described in terms of various embodiments, the invention should not be limited to only those embodiments described, but can be practiced with modification and alteration within the spirit and scope of the appended claims. The description is this to be regarded as illustrative rather than limiting.

What is claimed is:

1. A method of operating a wireless access node connected to a controller, the access node having a local port, comprising:
detecting a device connected to the local port,
interrogating the device connected to the local port to generate device information,
sending the device information to the controller,
generating by the controller a profile for the device, and
sending the profile from the controller to the access node.

2. The method of claim 1 where the local port is a USB port.

3. The method of claim 1 where the local port is an IEEE 1394 port.

4. The method of claim 1 where the local port is a wired Ethernet port.

5. The method of claim 1 where the step of generating a profile for the device further comprises:
sending queries from the controller to the access node,
executing the queries by the access node, targeting the device attached to the local port, and
sending information generated by executing the query to the controller.

6. The method of claim 1 where the profile contains information needed to operate the device attached to the local port.

7. The method of claim 1 where the profile contains access control information.

8. The method of claim 1 where the step of detecting a device connected to the local port takes place on access node startup.

9. The method of claim 1 where the step of detecting a device connected to the local port takes place when the device is connected to the local port.

10. The method of claim 1 where the step of generating a profile further comprises:
a database associated with the controller,
accessing the database to retrieve device and profile information, and
generating a profile from information retrieved from the database.
